(19) United States
(12) Patent Application Publication
(10) Pub. No.: US 2019/0025015 A1
(43) Pub. Date: Jan. 24, 2019

(54) FOAM ENCAPSULATED BALLISTIC PLATE

(71) Applicant: Central Lake Armor Express, Inc., Central Lake, MI (US)

(72) Inventors: Matthew A. Davis, Rapid City, MI (US); Jonathan J. MacNeil, Rapid City, MI (US); Michael A. Criswell, Bellaire, MI (US)

(21) Appl. No.: 15/857,993

(22) Filed: Dec. 29, 2017

Related U.S. Application Data
(60) Provisional application No. 62/445,962, filed on Jan. 13, 2017.

(51) Int. Cl. F41H 5/04; B32B 5/18; B32B 5/24; B32B 37/18

(52) U.S. Cl. CPC F41H 5/04; F41H 5/0414; F41H 5/0442; B32B 2571/02; B32B 5/18; B32B 5/245; B32B 37/18; F41H 5/0471

(57) ABSTRACT

A ballistic resistant armor plate assembly includes an armor plate which includes a strike side and a back side and a solid foam material positioned in overlying relationship with respect to the strike side and the back side of the armor plate.

### FIELD

This invention relates to a ballistic resistant body armor plate, and more particularly, to a ballistic resistant body armor plate worn by a user to protect the user from experiencing body trauma from a ballistic projectile impact.

### BACKGROUND

Ballistic resistant body armor plates have been used typically in conjunction with a ballistic resistant vest to provide the wearer additional protection than that provided by the ballistic resistant vest. In more recent times, it can be noted, where weight to the wearer was a concern ballistic resistant body armor plates have also been used in conjunction with carriers and without the use of a ballistic resistant vest. In the instance where the wearer will utilize the body armor plates with the ballistic resistant vest, there is typically a need to have protection against ballistic impacts from higher caliber weapons or rifles. The armor plates are often strategically positioned to overlie vital organ locations of the wearer and thereby provide optimal ballistic protection at those locations.

The ballistic body armor plates are constructed from a wide variety of selected materials. The armor plates are constructed of one of or a combination of materials. Examples of some of the materials that are considered to be used on their own or in combination with other materials in the construction of an armor plate include: metal compositions such as steel, titanium, aluminum and/or various alloys, etc.; ceramic compositions such as boron carbide or silicon carbide or other variants; plastic materials such as multi-layered sheets/plates of ultrahigh molecular weight polyethylene (UHMWPE); woven fabrics which are woven from one or more materials such as aramids fibers, UHMWPE fibers or other similarly strong fibers wherein woven plies overlie one another and can be used to form a laminate assembly; composites using high strength fibers in conjunction with a resin such as an epoxy; and carbon nanotube and nanocomposite materials as well as graphene. Since there is a wide variety of materials which are available from which to construct armor plates, fabricators can provide the particular additional protection as needed for the wearer. In situations where special threat armor plates are needed with a notably higher ballistic rating (NIJ standard) than a ballistic resistant vest may normally provide, a fabricator may often rely on use of a combination of these above-mentioned materials or one or more of these materials with at least one other material known to be employed in the construction of ballistic resistant body armor plates.

In use, a ballistic body armor plate which receives a ballistic impact can result in a user experiencing an unwanted event. For example, a ballistic resistant body armor plate which includes a laminate structure, in some instances, upon ballistic impact can experience delamination of the laminate structure. In other instances, upon receiving a ballistic impact, an armor plate constructed of a material which provides a hard surface, such as a ballistic resistant armor plate constructed of a metal or ceramic or the like, can experience a spalling event at the location of the ballistic impact. The spalling event results in fragments originating from the breakup of the projectile and/or the breakup of the surface of the body armor plate at the area of impact. These fragments can then become unwanted secondary projectiles which further endanger the wearer. Similarly, this could be said for an event of a ricochet of a ballistic round off of a hard surface of a ballistic resistant body armor plate. In other occurrences of a ballistic impact onto a body armor plate, particularly with certain body armor plates constructed of a softer material, such as, for example, a woven material, the ballistic impact can create a back face deformation or signature of the armor plate causing unwanted injury from the deformation to the wearer. There is a need to mitigate these unwanted events that can result from a ballistic impact onto a ballistic resistant body armor plate.

The wearing of a ballistic resistant armor plate provides the wearer with the benefit of additional ballistic resistant protection but also provides the wearer additional burdens with the wearing of the body armor plates. The body armor plates worn in conjunction with a ballistic vest add further additional weight to be carried by the wearer and at the same time the armor plates typically lack buoyancy. The additional weight can bring on earlier fatigue to the wearer and the lack of buoyancy can further endanger the wearer, particularly when the wearer encounters a deep water environment while wearing the ballistic resistant vest carrying the armor plates. There is a need to provide body armor plate assemblies that provide optimal lightweight characteristics and that provide optimal buoyancy as well.

Moreover, certain armor plates need environmental protection for their optimal performance. In the instance of an armor plate constructed of a ceramic material, care and protection needs to be taken so as not to chip or crack the ceramic material. Chipping and/or cracking a ceramic plate can occur with simply dropping the ceramic armor plate onto a hard surface. A chipped or cracked ceramic armor plate can impair the optimal stopping capability of the ceramic armor plate. Protection to an armor plate constructed of a ceramic material from impacting a hard surface is needed to assure optimum performance of the armor plate.

Attempts have been made to enclose and protect an armor plate. One of those attempts involved an application of a coating such as polyurea. Polyurea is a relatively hard coating and is not conducive to provide a cushioned back face structure should a back face deformation event arise from a ballistic impact. The polyurea material which provides a relatively hard and dense coating surface to a body armor plate is also not conducive to provide beneficial buoyancy or be optimally resilient to provide impact resistance protection to a ceramic armor plate that may be dropped or otherwise experience an impact onto a hard surface.

Other materials such a nylon or polyurethane sheet materials have been used to enclose a ballistic resistant armor plate. These materials, for example, are glued together outside and around the perimeter of the armor plate. These enclosures provide water repellent protection for the body armor plate as would a polyurea coating but do not provide significant buoyancy. The polyurethane or nylon materials do not provide significant cushioning on a back face deformation or signature event that may occur at the time of a ballistic impact event. The enclosure for an armor plate constructed of these materials do not provide significant support or confinement to a ballistic resistant body armor plate that has incurred a ballistic impact that promotes delamination of the body armor plate. Additionally, the polyurethane or nylon covering materials do not provide significant resilient impact absorbing protection to, for example, a ceramic armor plate that is dropped onto or otherwise impacts a hard surface so as to protect the ceramic armor plate from incurring cracking or chipping.

### SUMMARY

An example of a ballistic resistant armor plate assembly includes an armor plate which includes a strike side and a back side and a solid foam material positioned in overlying relationship with respect to the strike side and the back side of the armor plate.

An example of a method of assembling a ballistic resistant armor plate assembly includes the step of positioning solid foam in overlying relationship to a strike side of an armor plate and positioning solid foam in overlying relationship to a back side of the armor plate such that a portion of the solid foam in overlying relationship to the strike side of the armor plate extends beyond a perimeter of the armor plate and a portion of the solid foam in overlying relationship to the back side of the armor plate extends beyond the perimeter of the armor plate. The method further includes heating and compressing the solid foam in overlying relationship to the strike side of the armor plate and heating and compressing the solid foam in overlying relationship to the back side of the armor plate.

The features, functions, and advantages that have been discussed can be achieved independently in various embodiments or may be combined in yet other embodiments further details of which can be seen with reference to the following description and drawings.

### BRIEF SUMMARY OF THE DRAWINGS

FIG. 1 is a perspective view of a first example of the ballistic resistant body armor plate assembly;

FIG. 2 is an end profile view of the first example of the ballistic resistant body armor plate assembly of FIG. 1 as seen along line 2-2;

FIG. 3 is a cross section view of a second example of the ballistic resistant body armor as seen along line 3-3 of FIG. 1 wherein an additional fabric layer is positioned on opposing sides of the armor plate assembly;

FIG. 4 is an exploded unassembled cross section view of the components of the ballistic resistant body armor plate assembly of FIG. 3;

FIG. 5 is a cross section view of a third example of the ballistic resistant body armor plate assembly of FIG. 1 as would be seen along line 3-3 wherein an additional fabric layer is positioned on opposing sides of the armor plate assembly and an adhesive layer is positioned between each successive layered component of the ballistic resistant body armor plate assembly; and

FIG. 6 is an exploded unassembled cross section view of the ballistic resistant body armor plate assembly of FIG. 5.

### DESCRIPTION

As mentioned earlier, ballistic resistant body armor plates are typically used in conjunction with a ballistic resistant vest and provide additional ballistic resistant protection. However, in some instances where additional weight is a concern to the wearer ballistic armor plates are used in association with a carrier and without the use of a ballistic resistant vest. The wearer of the ballistic resistant vest will insert the ballistic resistant body armor plates into or otherwise secure the plates to the ballistic resistant vest. The plates will be strategically positioned at locations so as to provide enhanced protection of vital organ(s) of the wearer at those locations. As discussed earlier, the ballistic resistant body armor plate(s) will typically be fabricated to provide the location(s) with protection from a higher caliber weapon or rifle which may be above the design of the ballistic vest. In some applications armor plates may be used in conjunction with a ballistic resistant vest to thwart other threats than ballistic. Ballistic resistant body armor plates are constructed from one or more ballistic resistant materials. There are a wide variety of constructions and compositions of ballistic resistant body armor plates which the fabricator can select from to address ballistic resistant needs for the wearer.

As discussed earlier, ballistic impact onto a ballistic resistant body armor plate can result in some unwanted events or occurrences, as discussed earlier. The unwanted events may occur based on a number of different factors. Some of these factors can include the particular construction of the ballistic resistant body armor plate, the hardness of the strike surface of the plate, the velocity, size and makeup of the projectile and the angle of impact of the projectile. Any one of or a combination of these factors may contribute to an unwanted event as a result of a ballistic impact to the armor plate.

In an example of a ballistic impact where the construction of the ballistic resistant body armor plate is a laminate structure, a ballistic impact on the strike face can impart an undesired shear force onto the laminate. A sufficient shear force can promote an unwanted delamination of the ballistic resistant body armor plate rendering the body armor plate subsequently less or none effective. Providing secure confinement of a laminated armor plate provides alignment support to the laminated structure so as to reduce the occurrence of and/or the effect of a delamination event.

In an example of a ballistic impact where the ballistic resistant body armor plate is constructed of a particularly hard surface, such as that of ceramic or metal material, a ballistic impact on the strike face of the ballistic resistant armor plate can contribute to an undesired spalling event occurring at the strike face. Spalling results in unwanted fragment projectile(s) originating from the breaking up of the original impacting projectile, from breaking up of a portion of the body armor plate at the point of impact or from both. Similarly, in the instance where certain hard surface of the ballistic resistant plate is impacted by a ballistic round with an angular impact, an unwanted ricochet can occur. Providing resilient confinement of the armor plate will assist in mitigating unwanted fragment projectiles.

In another example of an unwanted event occurring at the time of a ballistic impact on a strike face of a ballistic resistant body armor plate, the impact can result in an unwanted back face deformation of the body armor plate causing injury to the wearer. A cushioned resilient confinement of the ballistic armor plate can provide mitigation of injury to the wearer with a cushioned distribution of force to the wearer from the deformation.

Mitigation of unwanted occurrences or events such as delamination, spalling and/or back face deformation from a ballistic impact onto the ballistic resistant body armor plate would be beneficial to the wearer. The ballistic resistant body armor plate assembly to be described herein will provide mitigation with respect to these unwanted occurrences or events from a ballistic impact onto a ballistic resistant body armor plate with providing a secure encapsulation of a solid foam material about a ballistic resistant body armor plate.

In addition, it would be beneficial to minimize the weight associated with a body armor plate assembly having an enclosing feature so as to minimize fatigue to the wearer. It would also be beneficial to provide buoyancy to a ballistic resistant body armor plate so as to provide the wearer additional safety should the wearer be subjected to a water environment while wearing a ballistic resistant vest which carries ballistic resistant body armor plates or with, as mentioned earlier, wearing a carrier carrying ballistic resistant body armor plates. The ballistic resistant body armor plate assembly to be described herein will provide minimizing of the weight related to a body armor plate assembly and maximizing the buoyancy of the body armor plate assembly with providing an encapsulation of a solid foam material about the ballistic resistant body plate, as will be described herein.

Additionally, it would beneficial to provide protection to ballistic resistant body armor plates constructed of a hard material such as ceramic so as to reduce the occurrence of chipping and/or cracking of the ceramic material should the armor plate be dropped or otherwise experience impact with a hard surface. The ballistic resistant body armor plate assembly to be described herein will provide this benefit with encapsulating the ceramic armor plate with a solid foam providing a resilient protective covering to the ceramic armor plate.

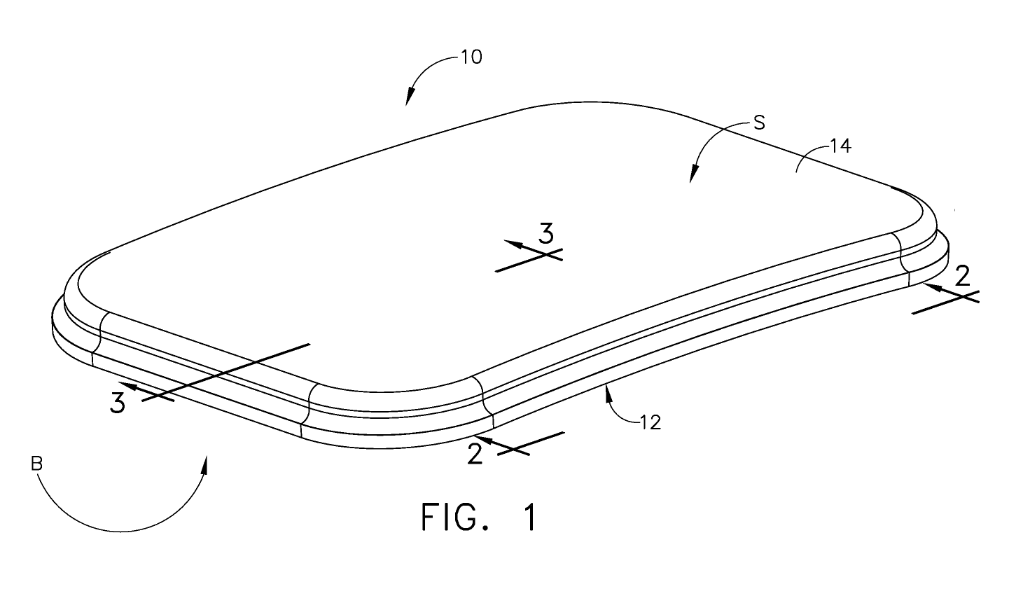

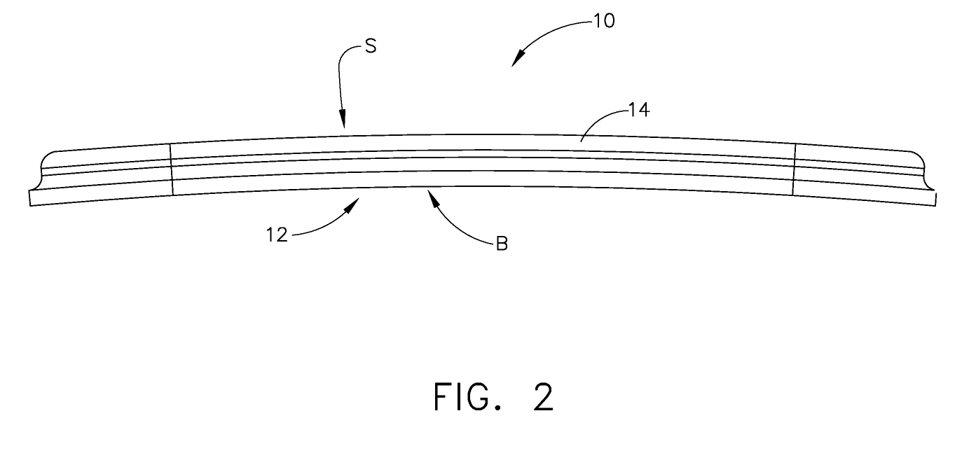

In referring to FIGS. 1 and 2, first example of ballistic resistant body armor plate assembly 10 is shown. The shapes and sizes of ballistic resistant body armor plate assembly 10 can vary, which is the case for the configuration of all ballistic resistant body armor plate examples discussed herein. Examples of the configurations can include rectangular, rectangular with rounded corners, hexagonal and many other shapes as needed for proper positioning and needed protection at desired strategic locations on the wearer.

Armor plate assembly 10 can be inserted within or otherwise secured to a ballistic resistant vest providing needed strategic additional ballistic protection for the wearer, as is the case for all examples of armor plate assemblies discussed herein. Armor plate assembly 10 and the other examples described herein can also be used in association with a carrier and employed in the construction of a ballistic shield and in the construction of a ballistic barrier. As mentioned above, the armor plate assemblies can be also carried within a carrier without the employment of a ballistic resistant vest. Additionally, the armor plate assembly technology described herein can also be applied to the construction of ballistic shields and/or ballistic barriers, as mentioned earlier. As shown in FIG. 2, first example of armor plate assembly 10 includes a contour 12 which extends along a length of armor plate assembly 10 and provides a shape for conforming armor plate assembly 10 to a portion of the torso of a wearer. Contour 12 can be provided as needed to all armor plate assemblies to be described herein and contours can be positioned along a length and/or a width of the plate as needed. Similarly, shapes and/or contours can be applied in the construction of a ballistic shield and ballistic barriers, as well as. This will also be the case for other criteria to be discussed herein with respect to the construction and substrates of the armor plate assemblies discussed herein.

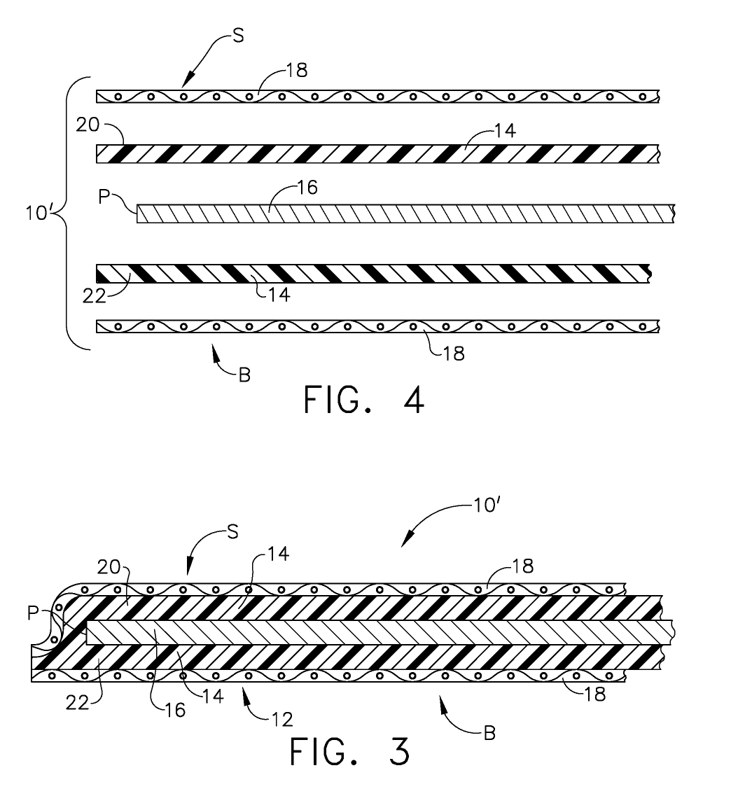

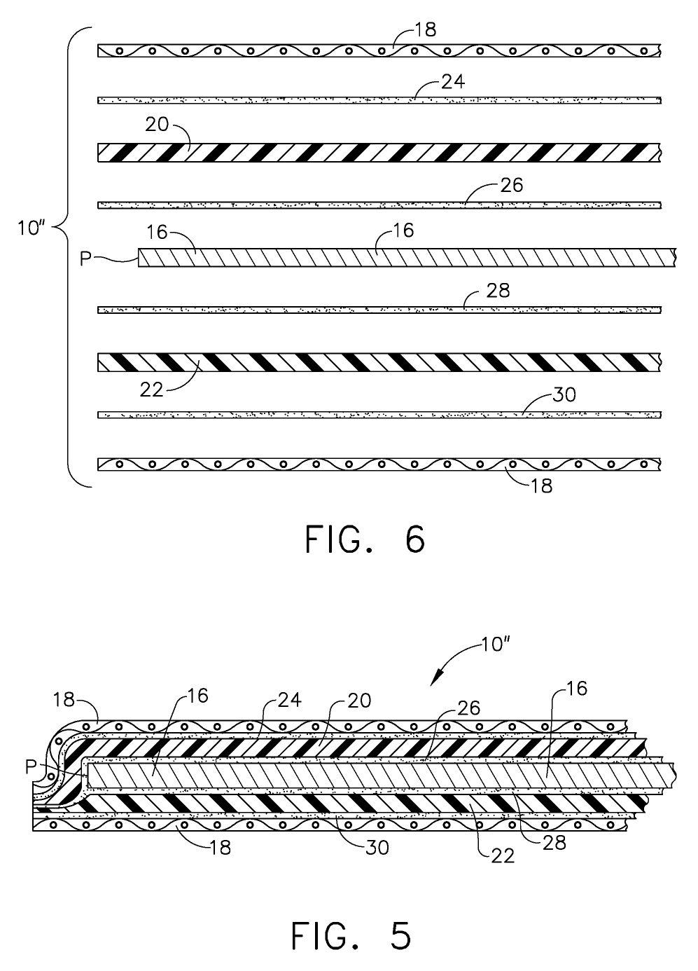

Strike face S and back face B of first example of ballistic resistant body armor plate assembly 10 demonstrates the orientation of body armor plate assembly 10 as worn by the wearer. This orientation is also provided for second example of body armor plate assembly 10′, as shown in FIGS. 3 and 4; and for third example of body armor plate assembly 10″, as shown in FIGS. 5 and 6.

The dimensions of coverage provided to the wearer of the armor plate assembly for each of the first, second and third examples 10, 10′and 10″ respectively can vary as can the thickness for the armor plate assemblies. Ballistic resistant body armor plates are made in numerous coverage dimensions for the wearer, configurations and thicknesses. In first example 10 shown in FIG. 1, the rectangular configuration with rounded corners has a wearer coverage of approximately five and one half inches (5.5 in.) by eight and one half inches (8.5 in.). The rounded corners have approximately one and one half inch (1.5 in.) radius. The overall thickness of this first example of armor plate assembly 10 is approximately one quarter of an inch (0.25 in.).

With respect to armor plates used with concealed ballistic resistant vests are generally constructed with smaller dimensions of coverage and smaller thicknesses than ballistic resistant body armor plates used with strategic ballistic resistant vests. Dimensions of coverage and thicknesses of the body armor plates will be determined and provided as needed for the particular protection required.

An outer portion of the first example of body armor plate assembly 10 includes a solid foam material which will be discussed in more detail herein. Solid foam material 14 overlies opposing sides of armor plate 16 as shown for example in FIGS. 3 and 4 (which shows the construction of second example of body armor plate assembly 10′). The difference between the first example of ballistic resistant body armor plate assembly 10 and the second example of ballistic resistant body armor plate assembly 10′ is that second example of armor plate assembly 10′ includes a fabric layer 18, which will be discussed in further detail herein, positioned outside of solid foam 14. First example of ballistic resistant body armor plate assembly 10 of FIGS. 1 and 2 and second example of ballistic resistant body armor plate assembly 10′ both have solid foam 14 overlying opposing sides of armor plate 16, as shown in FIGS. 3 and 4. Additionally, both first example of armor plate assembly 10 and second example of armor plate assembly 10′ have solid foam 14 encapsulating armor plate 16.

Armor plate 16 for all of first, second and third examples 10, 10′ and 10″ can be constructed from one of many different constructions and be composed of one of or a combination of compositions used for making armor plate 16. Materials or compositions that are considered in the construction of armor plate 16 include materials, as mentioned earlier, such as: metal, ceramic, fabric, plastic, woven fabrics, composites, carbon nanotube, nano-composite materials as well as graphenes and others. These materials can be used alone or in select combination with each other and/or with other materials used in the construction of armor plates. It is often the case, with fabricating plates for higher ballistic ratings under NIJ standards, to use more than one of these materials. The fabricator can choose one or more materials as needed to provide the protection to the wearer that is needed. For construction of armor plate 16 for any of the examples of ballistic resistant body armor plate assemblies 10, 10′ and 10″, the ballistic stopping capability of armor plate 16 will be greater than the other component(s) used in the construction of these assemblies 10, 10′ and 10″.

These different constructions and compositions for armor plates 16 are known in the industry. One material for example includes the use of metals such as for example steel, titanium, aluminum and various alloys. Metal materials are known to be well suited for reducing blunt trauma and for breaking up of an impacting ballistic projectile.

Other materials used in the fabrication of armor plate 16 include ceramics such as those which include boron carbide and silicon carbide and variants and the like. These materials are generally lighter materials than metal materials and have a hard surface which deform and/or break up impacting ballistic projectiles similar to metal but generally does not perform as well as metal with respect to repeat impacts in a localized area and generally do perform as well as a metal counterpart with respect to blunt trauma.

Armor plates 16 that are constructed of fabric are generally softer and do not perform as well on blunt trauma. These fabric armor plates 16 are often constructed of aramid woven fibers or similar high strength fibers such as those made of ultra-high molecular weight polyethylene or other materials. In fabric applications, because of their softer construction, sheets of metal or ultra-high molecular weight polyethylene, carbon fiber, glass fiber and/or quartz fiber based materials are also employed to provide stiffness and some trauma protection.

In other constructions of armor plate 16, plastic may be employed in layers such as those constructed of ultra-high molecular weight polyethylene. Additional constructions may include composite materials that include high strength fibers and epoxy based or various other resins used in composite construction can also be employed in the construction of armor plates 16. Other materials that may be used include the application of carbon nanotube, nanocomposite materials and grapheme, as well as others.

The thickness of armor plate 16 can vary as needed based on the materials used and ballistic resistance needed. In application with concealed armor, armor plate 16 generally does not exceed one quarter inch (0.25 in.) in thickness, however, the thickness can exceed this amount and is constructed as determined by the fabricator for the ballistic protection intended. In tactical body armor the thickness of armor plate 16 is generally not in excess of one half inch (0.50 in.) in thickness and again the thickness can exceed this amount and is constructed as determined by the fabricator for the ballistic protection intended.

Armor plate 16 for either first or second example 10 and 10′ has solid foam 14 positioned on opposing sides of armor plate 16 as seen for example in FIGS. 3 and 4. In these examples solid foam 14 securely confines and encapsulates armor plate 16. Solid foam 14 has layer 20 overlying a strike side S of armor plate 16 for each of first and second examples of body armor plate assemblies 10 and 10′ and solid foam 14 material has layer 22 overlying a back side B for each of first and second examples of body armor plate assemblies 10 and 10′.

In first example of armor plate assembly 10, layers 20 and 22 of solid foam are heated in preparation of compression molding and armor plate 16 is positioned between layers 20 and 22 of solid foam 14 and this layered assembly is positioned within a compression mold. Layers 20 and 22 and armor plate 16 are pressed together molding solid foam 14 to encapsulate armor plate 16 with layers 20 and 22 of solid foam 14. Solid foam 14 is heated to facilitate securement and assembly of the substrates and to facilitate the deforming and molding of the solid foam into the desired shape closely fitting about armor plate 16 with the application of the compressive force by the compression mold. In some examples of use of polyethylene low density cross linked solid foam the foam can be heated to a temperature of approximately three hundred degrees Fahrenheit (plus or minus) (+or −300° F.) for making the foam pliable for the compression molding. The heat and compressive force applied will be optimally set based on factors such as the chemical composition of the solid foam selected, the density thereof and the thickness employed.

In the instance of first example of armor plate assembly 10, layers 20 and 22 of solid foam 14, based on the chemical composition, density and thickness of the solid foam 14 sufficient heat will be imparted to the solid foam 14 and a compression force will be employed to compress and mold solid foam 14 about armor plate 16 and bond solid foam 14 to armor plate 16. Portions of layers 20 and 22 which extend beyond and about a perimeter P, as seen for example in FIG. 4, of armor plate 16 are compressed together with sufficient force such that these heated portions of solid foam 14 fuse together, as seen in FIG. 3 (without fabric 18). The compression molding of solid foam 14 securely confines and encapsulates armor plate 16 on opposing sides of armor plate 16 and along perimeter P of armor plate 16 as seen in FIG. 3, as an example. Any excess solid foam 14 material is cut off and first example of armor plate assembly 10 is formed as seen in FIGS. 1 and 2.

This is similarly the case for assembling second example of armor plate assembly 10′ as shown in FIGS. 3 and 4. In second assembly 10′ a fabric layer 18, to be discussed in more detail below, is positioned to overlie each solid foam layer 20 and 22. Again layers 20 and 22 are heated, as mentioned earlier to facilitate bonding of the substrates and deforming and molding of solid foam layers 20 and 22, armor plate 16 is positioned in between layers 20 and 22 and fabric 18 is placed on a side of layer 20 as seen in FIGS. 3 and 4 and fabric 18 is placed on a side of layer 22 as seen in FIGS. 3 and 4. A layered assembly of the components for second example 10′ includes fabric 18, layer 20 of solid foam 14, armor plate 16, layer 22 of solid foam 14 and fabric 18 as seen in FIG. 4. This layered assembly of components is placed in a compression mold and pressed together laminating fabric 18 to layers 20 and 22 of solid foam and solid foam 14 layers 20 and 22 bonding to armor plate 16. The heat applied and compression force exerted to mold and encapsulate solid foam 14 about armor plate 16 and bond layers 20 and 22 to armor plate 16 will depend on the chemical composition of solid foam 14 and the density of solid foam 14.

As seen in FIGS. 3 and 4, layers 20 and 22 and fabric 18 all extend beyond perimeter P of armor plate 16. With a portion of the solid foam 14 of layers 20 and 22 which extend beyond perimeter of armor plate 16 sufficiently heated and compressive force applied, layers 20 and 22 fuse together and fabric 18 in overlying relationship to layers 20 and 22 of solid foam 14 laminate to respective layers 20 and 22. Armor plate 16 is securely confined and encapsulated within solid foam 14 with fabric 18 positioned on the outer surface of second example of armor plate assembly 10′. Fabric 18 positioned on opposing sides of second example of armor plate assembly 10′ provides a durable surface and protects layers 20 and 22 from abrasive forces and is slip resistant and provides a user to reliably grip and hold the armor plate assembly 10′. Fabric 18 is also tear resistant to maintain the protection of solid foam layers 20 and 22. Examples of fabric 18 will be discussed in more detail below. This secure encapsulated confinement of armor plate 16 with solid foam 14 material for both first and second examples of armor plate assemblies 10 and 10′ provides the needed beneficial performance for armor plate assemblies as discussed earlier. The foamed encapsulation confines armor plate 16 and provides beneficial performance for armor plate assemblies 10 and 10′ as identified above such as mitigating adverse events presented to armor plates that experience ballistic impact such as delamination, spalling and back face deformation. In addition, the solid foam encapsulation provides a lightweight profile to armor plate assemblies 10 and 10′ as well as being a buoyant material (particularly for closed cell solid foams). In addition, the solid foam 14 encapsulation provides a resilient protective cover to prevent chipping and/or cracking of a ceramic armor plate 16 should plate 16 be dropped onto or otherwise impact a hard surface. These beneficial performances will also be the case for third example of ballistic resistant body armor plate assembly 10″ which will be discussed below.

Solid foam 14 encapsulates armor plate 16, as mentioned above, in both examples of ballistic resistant armor plate assemblies 10 and 10′ shown in FIGS. 1-4 as described above. The encapsulating of armor plate 16 with solid foam 14 can be accomplished using one of a variety of solid foam materials. The fabricator can select an open or closed cell solid foam material depending on the performance the fabricator wishes to obtain. The solid foam material 14 can be constructed from one of a wide range of materials such as cross-linked polyethylene; polyurethane; EVA (ethylene-vinyl acetate); expanded polyethylene non cross-linked, cross-linked polyolefin and variants of these materials. Solid foam 14 material can be selected from a wide range of densities including but not limited to one pound to fifteen pounds per cubic foot. The thickness of each layer 20 and 22 can be selected from a wide range of thicknesses generally including but not limited to 0.025 inches up to and including 0.50 inches. As needed, back face B solid foam 14 layer such as layer 22, as seen in FIGS. 3 and 4, is constructed thicker in dimension than, for example, layer 20 of solid foam 14 positioned at strike face S, so as to provide needed protection of the wearer from back face B deformation at the time of a ballistic impact. The thicknesses of layers 20 and 22 can be increased from the range mentioned above as desired. The type of solid foam 14 material and the thickness of the material can be selected as needed by the fabricator to provide the beneficial performance for an armor plate assembly for the wearer as discussed herein.

For first and second examples of armor plate assemblies 10 and 10′ discussed above, solid foam 14 is heated to a temperature for the material selected which will permit compression molding to encapsulate armor plate 16. In the above discussed examples of solid foam 14, adequate heat will be applied and compressive forces with a compression mold to fuse together portions of layers 20 and 22 which extend beyond perimeter P of armor plate 16. Heating and compressive force will be applied to bond layers 20 and 22 to armor plate 16 and to mold solid foam 14 about armor plate 16. In the second example 10″ sufficient heat and compressive force will be applied to also laminate fabric 18 to layers 20 and 22 of solid foam 14.

With respect to fabric 18, this fabric can be one of many types of fabrics. Fabric 18 can be woven or nonwoven or a combination of these configurations. Additionally, fabric 18 can include a plurality of plies of the same or of different materials. In this example fabric 18 includes a woven fabric made of nylon having a denier of 500 and manufactured by Tweave Inc. of Norton, Mass. The material referred to herein as Tweave, a trademark of Tweave, Inc., is composed of a Nylon/Spandex blend and having a fabric weight of 6.5 ounces per square yard; 24-30% stretch in warp direction; 23-29% stretch in fill direction; Class 5 abrasion resistant and 100% spray rating for water repellency. The material provides, an abrasion resistant surface protecting underlying solid foam 14 and provides a friction surface for gripping and handling of second armor plate assembly 10′. Fabric 18 is generally tear resistant as well so as to sustain its protective performance. Fabric 18 can be selected from a wide range of other fabrics such as for example at least one of nylon cordura, chlorofulthonated polyethylene, nylon polyester blend, cotton, cotton blend, spandex, fiberglass, carbon fiber, acrylics or polypropylene or others.

A third example of armor plate assembly 10″ is shown in FIGS. 5 and 6. The principal components of this armor plate assembly 10″ similarly includes the components of second example 10′, as shown in FIGS. 3 and 4, which include fabric 18, layers 20 and 22 of solid foam 14 and armor plate 16 as described above. However, third assembly 10″ utilizes an additional component which includes adhesive film layers 24, 26, 28 and 30. Adhesive film layers can be positioned between each substrate in assembly 10″ or selectively interposed between substrates as needed. Alternatively, in place of an adhesive film being used an adhesive which is applied such as by way of spraying or coating or otherwise will be referred to as an applied adhesive. These applied adhesives can be selected from a wide variety of applied adhesives such as thermoset, thermoplastic or epoxy.

Not all substrates of the assembly may need an adhesive layer, whether originating as a film or as an applied adhesive, such as for example where at least one of the substrates that adjoins another would have sufficient adhesive qualities such that a layer of adhesive film or an applied adhesive is not needed.

In the present example, these adhesive layers can be selected for optimal securement of adjoining components of fabric 18, layers 20 and 22 of solid foam 14, and armor plate 16 as seen in FIGS. 5 and 6. In this example, adhesive film layer 24 is positioned between fabric 18 positioned on the strike side of the assembly and layer 20 of solid foam 14. Adhesive film layer 26 is positioned between layer 20 of solid foam 14 and armor plate 16. Adhesive film layer 28 is positioned between armor plate 16 and layer 22 of solid foam 14. Adhesive film layer 30 is positioned between layer 22 of solid foam 14 and fabric 18 on the back side of the assembly. Each adhesive film layer 24, 26, 28 and 30, in this example, is selected to secure the material of the adjoining components between which the adhesive film layer is positioned or in which the applied adhesive has been positioned.

Examples of such adhesive film layer includes a film layer selected from a variety of thermoplastic polymers such as polyethylene, polypropylene, polystyrene and acrylics or from a variety of thermoset polymers such as vinyl esters, phenolic, polyimides, polyurethane and epoxy resins. Examples of the applied adhesives have been mentioned above.

Each adhesive film layer is generally coextensive in size of the adjoining component of the assembly the film layer is to secure on each of the strike side and the back side of the assembly, as seen in FIGS. 5 and 6 with respect to the third example assembly 10″, with the exception with respect to armor plate 16, as seen in FIGS. 5 and 6. Alternatively, the applied adhesives are applied to be coextensive with the adjoining component of the assembly the applied adhesive is to secure (not shown) with the exception of armor plate 16. One of the adhesive film layer 26, 28 or the applied adhesive (not shown) associated with the solid foam 20 of the strike side or the solid foam 22 of the back side is further positioned along a perimeter P of armor plate 16, as seen for example in FIGS. 5 and 6. In the example shown in FIG. 5, adhesive film layer 26 is positioned along perimeter P of armor plate 16.

Further included is a method of assembling a ballistic resistant armor plate assembly 10 includes the step of positioning solid foam 20 in overlying relationship to strike side S of an armor plate 16 and positioning solid foam 22 in overlying relationship to a back side B of armor plate 16 such that a portion of solid foam 20 is in overlying relationship to strike side S of the armor plate 16 and extends beyond a perimeter P of armor plate 16 and a portion of solid foam 22 in overlying relationship to back side B of armor plate 16 extends beyond perimeter P of armor plate 16. The method further includes heating and compressing solid foam 20 in overlying relationship to strike side S of armor plate 16 and heating and compressing solid foam 22 in overlying relationship to back side B of armor plate 16.

The method further includes a step of positioning a fabric 18 in overlying relationship to solid foam 22 positioned in overlying relationship to strike side S of armor plate 16 and a step of positioning fabric 18 in overlying relationship to solid foam 22 positioned in overlying relationship to back side B of armor plate 16.

The step of positioning further includes positioning one of an adhesive layer or an applied adhesive between one of: fabric 18 and the solid foam 20 in overlying relationship to strike side S armor plate 16; solid foam 20 in overlying relationship to strike side S of armor plate 16; fabric 18 and solid foam 22 in overlying relationship to back side B of armor plate 16; or solid foam 22 in overlying relationship to back side B of armor plate 16.

As mentioned above and seen in FIGS. 5 and 6, each of the components in the third example of body armor plate assembly 10″, except for armor plate 16, extends beyond perimeter P of armor plate 16. In this example, with the compression mold applying a compressive force to the portions of the components which extend beyond the perimeter P of armor plate 16 the components including fabric 18 adheres to solid foam layer 20, solid foam layer 20 adheres to armor plate 16 and along perimeter P of armor plate 16, solid foam layer 20 adheres to solid foam layer 22 and solid foam layer 22 adheres to fabric 18 resulting in armor plate 16 being enclosed within layers 20 and 22 encapsulating armor plate 16. Excess material from the components is cut away providing third example of armor plate assembly 10″.

Similarly as seen in FIGS. 3 and 4, with respect to the second example of body armor plate assembly 10′, each component except for armor plate 16 extends beyond perimeter P of armor plate 16. In this example, with the compression mold applying a compressive force to the portions of the components which extend beyond the perimeter P of armor plate 16, fabric 18 of the strike side adheres to solid foam layer 20, solid foam layer 20 adheres to perimeter P of armor plate 16 and solid foam layer 20 adheres to solid foam layer 22 and solid foam layer 22 adheres to fabric 18 on the back side resulting in armor plate 16 being enclosed within solid foam layers 20 and 22 encapsulating armor plate 16. Excess material from the components is cut away providing second example of armor plate assembly 10′.

Examples of the ballistic resistant body armor plate assemblies, but are not limited to these example assemblies with respect to this disclosure, include the following described examples. An example of a first assembly 10 includes armor plate 16 constructed of a three thousand denier (3000 den.) aramid thermoplastic system encapsulated with layers 20 and 22 of solid foam 14 composed of a low density cross linked polyethylene of a four (4) pound per cubic foot density. In one construction the woven aramid is in eight (8) plies. In a different construction the woven aramid is in twelve (12) plies. An example of a second assembly 10′ includes armor plate 16 constructed of a three thousand denier (3000 den.) aramid thermoplastic system encapsulated with layers 20 and 22 of solid foam 14 composed of a low density cross linked polyethylene of a four (4) pound per cubic foot density. In one construction the woven aramid is in eight (8) plies. In a different construction the woven aramid is in twelve (12) plies. The fabric 18 laminated to layers 20 and 22 includes a five hundred denier (500 den.) nylon construction as discussed above for Tweave.

An example of a third assembly 10″ includes armor plate 16 constructed of a three thousand denier (3000 den.) aramid thermoplastic system encapsulated with layers 20 and 22 of solid foam 14 composed of a low density cross linked polyethylene of a four (4) pound per cubic foot density. Layers 20 and 22 of solid foam 14 includes a low density cross linked polyethylene of a four (4) pound per cubic foot density. The fabric 18 includes a five hundred denier (500 den.) nylon construction as discussed above for Tweave. The adhesive films 24, 26, 28 and 30 are composed of thermoplastic polyethylene.

Another example of ballistic resistant body armor plate assembly includes the following layers within the assembly which includes a ballistic plate 16 of ceramic composition encapsulated in layers 20 and 22 of solid foam 14 of low density cross linked polyethylene. The assembly from the strike face side to the back side includes fabric 18 of Tweave; (0.125 inches) thick of low density polyethylene cross linked solid foam 14 layer 20; armor plate 16 constructed from an assembly of one layer of S2 (grade of fiber for) glass fabric with epoxy resin, 0.20 inches thick of silica carbide ceramic, one layer of S2 (grade of fiber for) glass fabric with epoxy resin and 0.25 thick consolidated UHMWPE; one layer of 0.20 inches thickness of expanded polyethylene non-cross lined solid foam 14 layer 22; polyethylene adhesive film; and fabric 18 of Tweave. In this example, with the outer layer of armor plate 16 assembly having a sufficient adhesive quality, this example does not require an adhesive film or an applied adhesive positioned between armor plate 16 assembly and layer 20 of solid foam 14 and does not require any adhesive film or applied adhesive between armor plate 16 assembly and layer 22 of solid foam 14.

While various embodiments have been described above, this disclosure is not intended to be limited thereto. Variations can be made to the disclosed embodiments that are still within the scope of the appended claims.

What is claimed:

1. A ballistic resistant armor plate assembly, comprising:
an armor plate which includes a strike side and a back side; and
a solid foam material positioned in overlying relationship with respect to the strike side and the back side of the armor plate.

2. The ballistic resistant armor plate assembly of claim 1, wherein the solid foam material encapsulates the armor plate.

3. The ballistic resistant body armor plate assembly of claim 1, wherein the armor plate comprises one of a metal, ceramic, woven aramid fibers, woven plastic fibers, plastic sheets, composite material comprising resin and fiber, carbon nanotubes, nano-composite materials or grapheme.

4. The ballistic resistant body armor plate assembly of claim 3, wherein the metal comprises steel, titanium or aluminum.

5. The ballistic resistant body armor plate assembly of claim 3, wherein the ceramic comprises boron carbide or silicon carbide.

6. The ballistic resistant body armor plate assembly of claim 3, wherein one of the woven plastic fibers and plastic sheets comprise ultra-high molecular weight polyethylene.

7. The ballistic resistant body armor plate assembly of claim 1, wherein the solid foam material comprises a closed cell foam or an open cell foam.

8. The ballistic resistant body armor plate assembly of claim 1, wherein the solid foam material comprises cross-linked polyethylene, polyurethane, ethylene-vinyl acetate (EVA), expanded polyethylene non cross-linked or cross-linked polyolefin.

9. The ballistic resistant body armor plate assembly of claim 8, wherein the solid foam has a density which in a range of densities which includes one pound up to and including fifteen pounds per cubic foot.

10. The ballistic resistant body armor plate assembly of claim 1 wherein the solid foam positioned in overlying relationship with the back side of the armor plate is thicker in dimension which extends away from the armor plate than the solid foam positioned in overlying relationship to the strike side of the armor plate which extends away from the armor plate.

11. The ballistic resistant body armor plate assembly of claim 1, further includes a fabric positioned in overlying relationship relative to the solid foam material.

12. The ballistic resistant body armor plate assembly of claim 11, wherein the fabric comprises woven or nonwoven fibers.

13. The ballistic resistant body armor plate assembly of claim 11, wherein the fabric comprises a nylon polyester blend, nylon cordura, chlorofulthonated polyethylene, cotton, cotton blends, spandex, fiberglass, carbon fiber, acrylics or polypropylene.

14. The ballistic resistant body armor plate assembly of claim 11, further includes:
one of an adhesive film layer or an applied adhesive is positioned between the armor plate and the solid foam which is positioned in overlying relationship with the strike side of the armor plate and one of an adhesive film layer or an applied adhesive is positioned between the armor plate and the solid foam which positioned in overlying relationship with the back side of the armor plate; and
one of an adhesive film layer or an applied adhesive is positioned between the fabric positioned in overlying relationship relative to the solid foam which is positioned in overlying relationship with the strike side of the armor plate and an adhesive film layer is positioned between the fabric positioned in overlying relationship relative to the solid foam which is positioned in overlying relationship with the back side of the armor plate.

15. The ballistic resistant body armor plate assembly of claim 14 wherein:
one of the adhesive film layer or the applied adhesive associated with the solid foam of the strike side or the solid foam of the back side is further positioned along a perimeter of the armor plate.

16. The ballistic resistant body armor plate assembly of claim 14 further included:
one of an adhesive film layer or applied adhesive is positioned between the fabric and the solid foam positioned in overlying relationship to the strike side of the armor plate and is coextensive to the fabric and the solid foam which extend in overlying relationship to the strike side of the armor plate; and
one of an adhesive film layer or applied adhesive is positioned between the fabric and the solid foam positioned in overlying relationship to the back side of the armor plate and is coextensive to the fabric and the solid foam which extend in overlying relationship to the back side of the armor plate.

17. The ballistic resistant body armor plate assembly of claim 11 wherein the adhesive film comprises a thermoplastic polymer or thermoset polymer.

18. A method of assembling a ballistic resistant armor plate assembly, comprising the steps of:
positioning solid foam in overlying relationship to a strike side of an armor plate and positioning solid foam in overlying relationship to a back side of the armor plate such that a portion of the solid foam in overlying relationship to the strike side of the armor plate extends beyond a perimeter of the armor plate and a portion of the solid foam in overlying relationship to the back side of the armor plate extends beyond the perimeter of the armor plate; and
heating and compressing the solid foam in overlying relationship to the strike side of the armor plate and heating and compressing the solid foam in overlying relationship to the back side of the armor plate.

19. The method of claim 18, positioning further includes:
a step of positioning a fabric in overlying relationship to the solid foam positioned in overlying relationship to the strike side of the armor plate; and
a step of positioning a fabric in overlying relationship to the solid foam positioned in overlying relationship to the back side of the armor plate.

20. The method of claim 19, the step of positioning further includes positioning an adhesive layer between one of:
the fabric and the solid foam in overlying relationship to the strike side of the armor plate;
the solid foam in overlying relationship to the strike side of the armor plate and the armor plate;
the fabric and the solid foam in overlying relationship to the back side of the armor plate; or
the solid foam in overlying relationship to the back side of the armor plate and the armor plate.
